(19) United States
(12) Patent Application Publication
(10) Pub. No.: US 2010/0318681 A1
(43) Pub. Date: Dec. 16, 2010

(54) PROTOCOL-INDEPENDENT, MOBILE, WEB FILTER SYSTEM PROVISIONING DNS TRIAGE, URI SCANNER, AND QUERY PROXY SERVICES

(75) Inventor: Fleming Shi, Cupertino, CA (US)

Correspondence Address: PATENTRY, P.O. BOX 151616, SAN RAFAEL, CA, 94915-1616, US

(73) Assignee: BARRACUDA NETWORKS, INC, Campbell, CA (US)

(21) Appl. No.: 12/484,046

(22) Filed: Jun. 12, 2009

(51) Int. Cl. G06F 15/16

(52) U.S. Cl. 709/245

(57) ABSTRACT

A system comprising three services: query string proxy, URI path scanner, and domain name system triage. A query string proxy sends a request on behalf of a client and analyzes the response from a remote server. A URI path scanner performs keyword matching on the entire path of a uniform resource identifier. A domain name system triage service receives a UDP request prior to establishing any protocol session between a client and a server and returns one IP address selected from the following: a block IP address, a trusted IP address, and a redirection to enhanced filter service IP address.

### BACKGROUND

Content-control software, or web filtering software, is a term for software designed and optimized for controlling what content is permitted to a reader, especially when it is used to restrict material delivered over the Web. Content-control software determines what content will be available on a particular machine or network; the motive is often to prevent persons from viewing content which the computer's owner(s) or other authorities may consider objectionable; when imposed without the consent of the user, content control can constitute censorship. Common use cases of such software include avoidance of websites known for malicious or undesirable purposes such as phishing, viruses, and spam; parents who wish to limit what sites their children may view from home computers, schools performing the same function with regard to computers found at school, and employers restricting what content may be viewed by employees while on the job. Individuals may wish to protect their home, work, or mobile computing devices from websites known to be hazardous.

A conventional Web filter software application is downloaded by a home user installed in a home computer. A database of websites and domains is maintained outside of the served computer. The user will select a number of categories of websites or domains that are allowed to be accessed by a http application that is a browser. Each website is rated for its text and images and placed in a category of the database. As a software product, a conventional Web filter requires a license and installation on each computer being protected.

A conventional filter examines a URI, consults a database, and interrupts access to a website according to the rating of the database and categories selected by a parent or administrator.

A conventional Web filter apparatus is a dedicated computer system comprising a plurality of network interfaces which can be installed by information technology professionals to protect a the group or organization at the intersection of their local area network with a wide area network or at the WAN edge. By installing a conventional Web filter apparatus into a network, a large number of web browsers can be protected without installing software on each computer.

Conventional Web filter solutions are known to those skilled in the art and protected by some of the following patents U.S. Pat. No. 6,947,985, entitled “Filtering Techniques for Managing Access to Internet Sites or Other Software Applications.” Other U.S. patents include U.S. Pat. Nos. 6,606,659, 5,678,041, 7,483,982, and 7,194,464.

Another technique known in the art is referred to as DNS hijacking. Hijacking of dns to filter websites is not scalable, dynamic or easy to maintain.

Hardware-based Web filtering solutions generally located at the intersection of a local area network and a wide area network are not portable and do not support mobile computer users who frequent libraries, Internet cafes, and airport hotspots. Home computer users are generally not sophisticated enough to do more than install software on their PC which is burdensome if there are several PCs in the home.

What is needed is a way to reduce the cost of ownership including installation and maintenance for a person who is less than a system administrator or who is a mobile computer user.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1 through 7 are data flow diagrams of a conventional web filter and embodiments of the presently claimed web filter system, method, and apparatus.

### SUMMARY OF THE INVENTION

The present invention comprises DNS Triage, URI Scanner, and Query Proxy Services. Each service comprises a processor adapted by a program product and coupled to each other via a network: query string proxy, URI path scanner, and domain name system triage.

The method comprises:
within a query string proxy apparatus
   sending a request on behalf of a client and
   analyzing a response from a remote server;
within a URI path scanner apparatus
   receiving an entire path of a uniform resource identifier, and
   performing keyword matching on labels within the uniform resource identifier;
within a domain name system triage service apparatus
   receiving a UDP request prior to establishing any protocol session between a client and a server and
   returning one IP address selected from the following:
      a block IP address,
      a trusted IP address, and
      a redirection to enhanced filter service IP address.

The method further comprises the following steps:
within a domain name system service apparatus,
   searching a database of domain names to determine if a block IP address or a trusted IP address corresponds to a domain name system, wherein a block IP address is one of a loopback address and an address of message server serving an html message;
within a URI path scanner apparatus,
   returning a block IP address if a label within the uniform resource identifier is matched with any member of a list of keywords consistent with undesirable content;
within a query string proxy apparatus,
   receiving from a server in response to any URI which triggers a script or program or database retrieval,
   analyzing the response for malicious scripts, viruses, images or text with undesirable content, and
   returning a message or block IP address to the client.

### DETAILED DISCLOSURE OF EMBODIMENTS

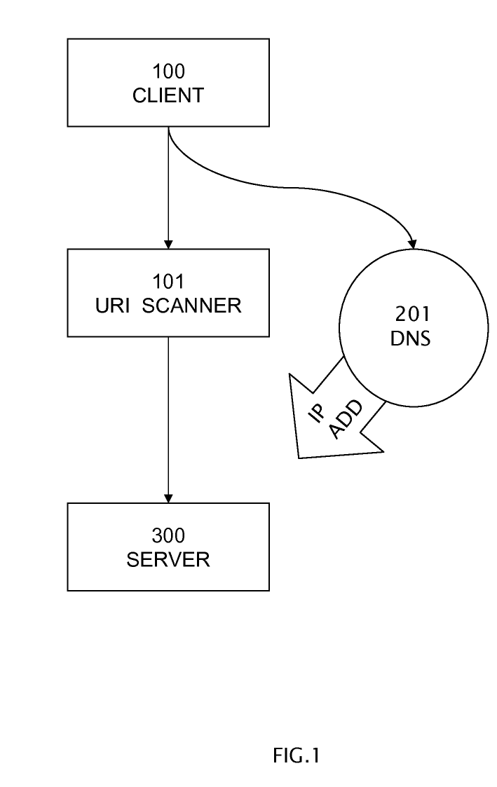

Referring now to the figures a conventional web filter and network configuration is illustrated in FIG. 1. A client 100 is configured with a software or hardware uniform resource identifier (URI) scanner 101 on the same machine or in the same local area network. In order to access the resource 300 in a wide area network such as the Internet, the client first requests a domain name system lookup from a domain name system (DNS) server to obtain an Internet protocol (IP) address. Domain name system servers are distributed across the Internet and are provided by the user's local area net administrator or Internet service provider among others. Installing a client on a network such as by DHCP determines which DNS server 201 a client 100 makes use of. In a conventional web filter system, a protocol is established between a client 100 and a server 300 and a uniform resource identifier scanner inspects the path of each uniform resource identifier transmitted.

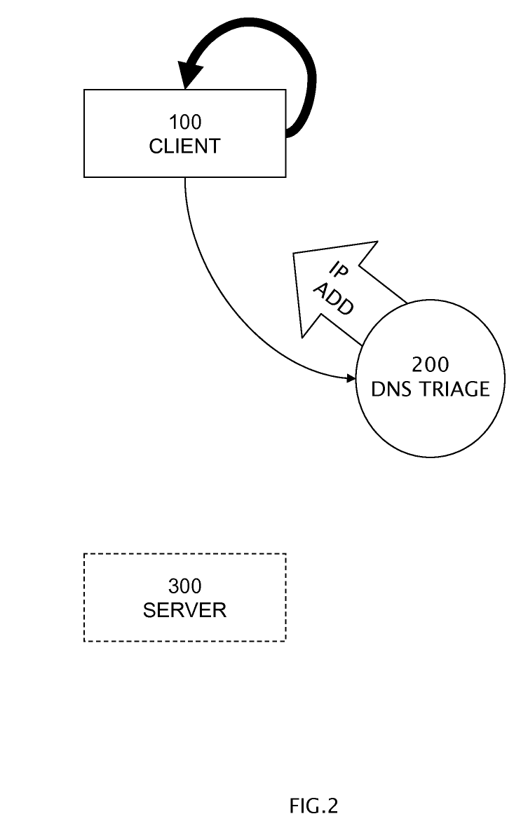

Referring now to FIG. 2. In the present invention a client 100 is adapted to direct domain name system queries to a certain DNS triage apparatus which comprises a block list and a circuit for receiving a domain name system request and retrieving an IP address. What is illustrated in FIG. 2 is that a domain name system request using a domain name for server 300, elicits a loop back address reply which is a conventional method of signaling a failure. Note that this operates at the UDP protocol level which is much more efficient than TCP/IP and that no protocol session is established with server 300 at all.

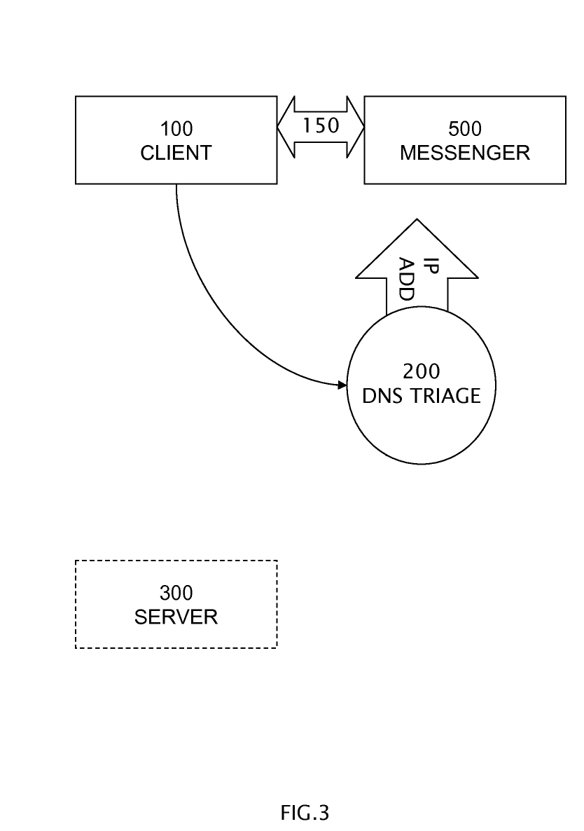

Referring now to FIG. 3. In an embodiment, the invention further comprises a web filtering portal response server we shall call within this disclosure the messenger 500. FIG. 3 illustrates the method where the domain name system request from the client 100 to the domain name system triage apparatus 200 elicits the IP address of the messenger 500. As a result the client 100 establishes a protocol session 1 50 with the messenger apparatus 500. In an example and http request receives a webpage in reply possibly generated by a script or a simple file which carries a warning or explanatory message. The advantage of this is to provide an explanation of the request denial rather than confusing the user with a perception of a possible network outage situation illustrated in FIG. 2.

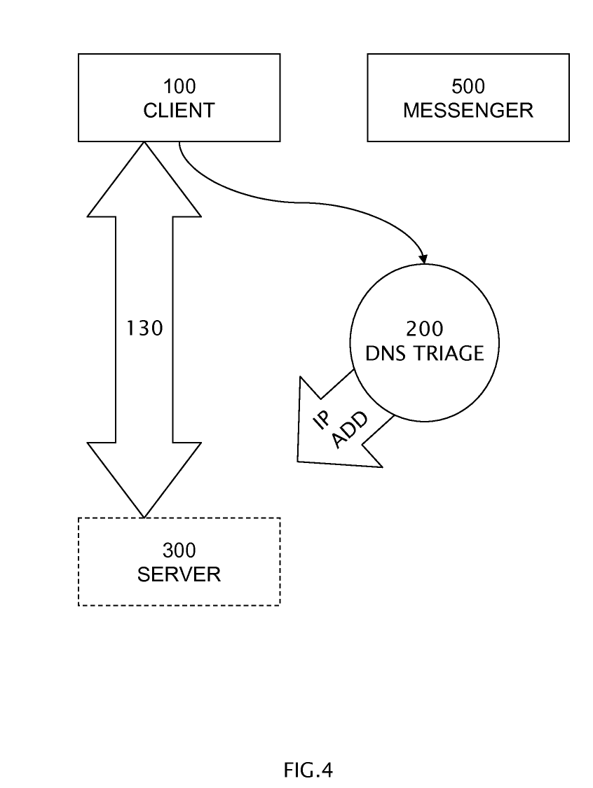

Referring now to FIG. 4, the domain name system triage apparatus 200 may further comprise a white list of trusted domain names and their validated Internet protocol addresses which upon request is provided to client 100. Using the validated Internet protocol address client 100 establishes a protocol session 1 30 with the server 300 and obtains the requested resource. The advantage of this method is to support a variety of Internet protocols including but not limited to http, https, FTP, and e-mail protocols.

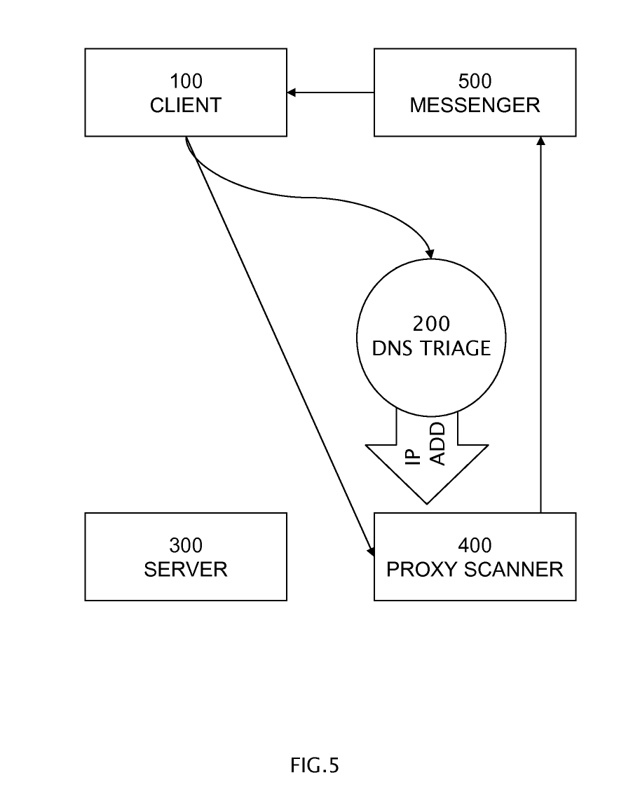

But some servers may be new or provide public hosting services or may not be totally trusted or not yet appear on any black list. The situation is addressed in FIG. 5 wherein the present invention further comprises a proxy scanner apparatus 400. FIG. 5 illustrates the situation where a client 100 has made a domain name system request from a domain name system triage apparatus 200 and obtains the Internet protocol address of the proxy scanner 400 because the domain name was not found either on a white list or a blacklist. As a proxy, the proxy scanner receives a complete uniform resource identifier including the protocol and the complete path as well as any query string appended to the end of the uniform resource identifier. The method includes the step of performing a deep URI scan on all of the labels and variables and parameters embedded in the uniform resource identifier including its protocol and query strings. In FIG. 5 the deep URI scan, comprising a search for keywords, has determined that the request should not be fulfilled. In an embodiment the client receives a message from the messenger directly or indirectly via the proxy scanner apparatus 400. It is understood that the messenger 500 the proxy scanner 400 and the domain name system triage apparatus 200 can be scalably distributed across devices interconnected via networks, or implemented by software and hardware in one or two devices.

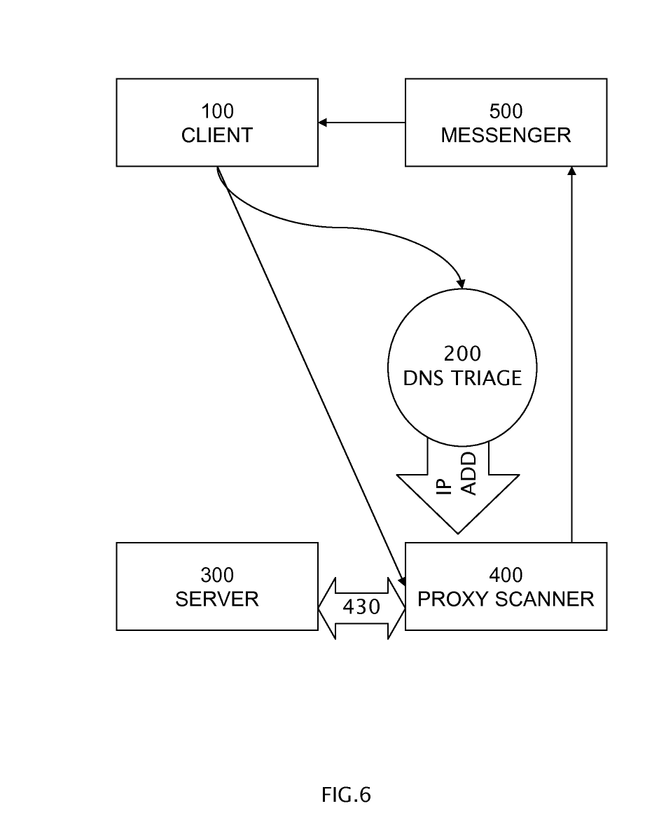

FIG. 6 illustrates the method steps further comprising establishing a protocol session 430 between the proxy scanner 400 and the server 300.

This allows a script or database query or transaction or program to be dynamically triggered by the uniform resource identifier and return a programmatic response which can be examined by the proxy scanner apparatus 400. If the proxy scanner apparatus 400 determines that the reply to the protocol session 430 includes undesirable content such as viruses, text or images considered undesirable, the client 100 receives a message warning or explanation directly or indirectly from the messenger apparatus 500.

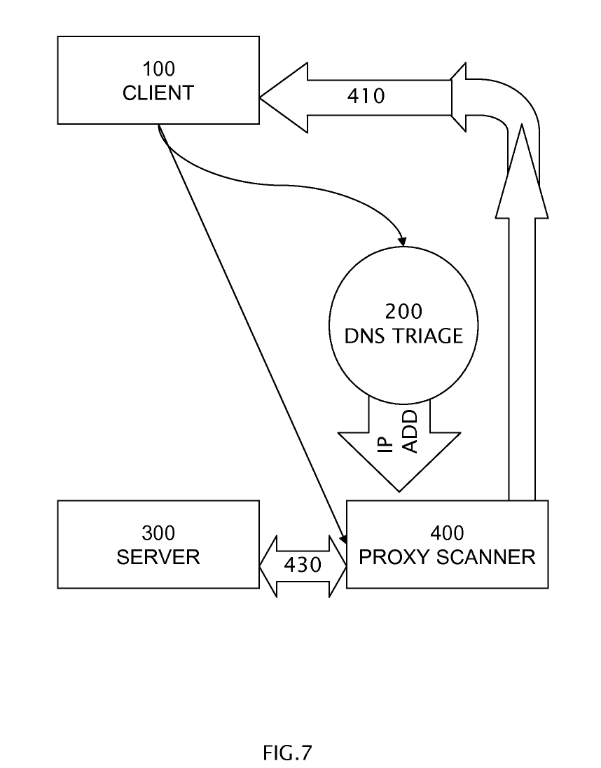

FIG. 7 illustrates the method of the invention further comprising the step after examining the response obtained by the protocol session between the proxy scanner and the server of transmitting the response to the client 100. The advantage of this situation is that the proxy scanner is not necessarily at the edge of the client's local area network and can be located anywhere in the Internet. Moreover clients can be mobile, use public access points such as cafes and libraries, client offices, or from their home without extensive network programming skills. Clients may be individual users operating on public computers having personalized domain name system triage profiles which are activated by logging in and user authentication.

The method comprises the steps for operating an apparatus, the apparatus comprising a Web filtering DNS server, a Web filtering response portal server, and a Web filtering extended proxy, the method comprising the steps of
receiving a DNS request from a client machine, and
responding with a yes answer based on policy control over the hostname of the DNS request.

If the answer is yes the actual IP address corresponding to the DNS request is sent to the client which the client uses for requesting HTTP services. If the answer cannot be determined by categorization and policy rule on the hostname part of the HTTP request, the traffic is rerouted to the Web filtering extended proxy. The Web filtering extended proxy will determine if the traffic is allowed based on the actual full URI of the HTTP request. The web filtering extended proxy may execute the HTTP request and examine the response to determine if the traffic is allowed. In an embodiment, a block page is served to the client machine on the condition that the web filtering DNS server can determine based on policy control over the hostname of the targeting web server that traffic is denied by returning the IP address of the Web filtering response portal server. In an embodiment a block page is served to the client machine on the condition that the Web filtering extended proxy determines that traffic is not allowed based on the full URI or on the content of the http response.

For ease of disclosure and to facilitate understanding, the elements of the invention are described as independent apparatus connected by a network. The elements can be connected inside of a local area network or a wide area network or elements of a local area network and a wide area network. It can be appreciated by those skilled in the art that the elements of the invention can be implemented within a single apparatus or where the elements are locally attached to one another as an equivalent. The Web filtering DNS server the Web filtering response portal server and the Web filtering extended proxy may be distributed among a server farm or combined into one or two apparatuses without changing the nature of the invention substantially.

The present invention is a system to provide a selective personalized Web filtering service by selective proxy using a domain name system comprising:
a network, the network coupling
a client machine apparatus,
a Web filtering domain name system server apparatus,
a Web server apparatus having a first Internet protocol address and a domain name.

The Web filtering domain name system server apparatus comprises
a white list database comprising at least one first Internet protocol address and a domain name, and
means for receiving a domain name request from the client machine apparatus.

In an embodiment, the Web filtering domain name system server apparatus comprises
a processor adapted by a software program to
search the white list for the domain name and, if found,
return the first Internet protocol address of the Web server apparatus to the client machine apparatus.

In an embodiment, the system further comprises
a web filtering extended proxy apparatus having a second Internet protocol address and wherein the Web filtering domain name system server apparatus comprises
a processor adapted by a software program
   to search a white list for the domain name and if not found,
   to return the second Internet protocol address of the Web filtering extended proxy apparatus,
      whereby the client machine is directed to send the actual full URI of an HTTP request to the Web filtering extended proxy apparatus.

In an embodiment the system further comprises a Web filtering response portal server having a third Internet protocol address comprising
means for receiving an HTTP request from a client machine apparatus and
means for serving a block page.

In an embodiment the Web filtering domain name system server apparatus further comprises
a blacklist database comprising at least one domain name and further comprising
a processor adapted by a software program
   to search the blacklist database for the domain name and if found
   to return the third Internet protocol address of the Web filtering response portal server
   whereby the client machine is directed to send actual full URI of an HTTP request to the Web filtering response portal server.

In an embodiment the client machine is adapted at network connection to send domain name system requests to the Web filtering domain name system server apparatus.

In an embodiment the client machine is adapted at user logon to send DNS requests to a certain personalized Web filtering domain name system server apparatus.

In an embodiment, the network comprises one of
a mesh network,
a cellular network, and
a wireless network.

In an embodiment the network is a wide area network.

In an embodiment the invention comprises an apparatus to provide a selective personalized Web filtering service by extended proxy comprising:
a plurality of network interfaces,
a circuit for receiving a full URI of an HTTP request,
a circuit for examining the full URI for a deeply buried URI within the full URI,
a circuit for determining if traffic to or from the buried URI is not allowed, and
a circuit for blocking the traffic if it is not allowed.

In an embodiment the apparatus further comprises
a blacklist database and
a processor adapted
   to examine a URI for buried URI on the blacklist and to block it if found.

In an embodiment the apparatus further comprises a proxy server apparatus adapted by a software program
to request a response from a Web server on behalf of a client and
to examine the response for objectionable content and
to return a block page if objectionable content is found.

In an embodiment the apparatus further comprises
a blacklist database of domain names and
a circuit for returning a third Internet protocol address on the condition that a client machine submits a DNS request containing a domain name found on the blacklist.

In an embodiment the apparatus further comprises a response server,
having a third Internet protocol address and
comprising means for serving a block page.

In an embodiment the apparatus further comprises authentication means of a client machine as a subscriber of a service.

In an embodiment the apparatus further comprises an authentication circuit of a user as a subscriber of a service.

In an embodiment the apparatus further comprises a circuit for fulfillment of a Web page request to the requesting client machine if no objectionable content is found and if the full URI does not contain a URI found in the blacklist.

### Conclusion

The present invention may be easily distinguished from conventional web filter methods and software program products by not requiring the installation of software in a client machine nor licensing of a client machine. The present invention may be easily distinguished from conventional DNS hijacking by not requiring administration authority or operating system programming skills.

The present invention may be easily distinguished from conventional web filter appliances, by not requiring the installation, configuration, and maintenance by information technology professionals of an apparatus at a wide area network edge. The present invention may be distinguished from conventional web filter solutions by operating independently of protocols unless the first DNS triage step redirects to enhanced filter services.

The present invention may be easily distinguished from conventional web filter proxy apparatus by ease of deployment for mobile business or personal web users visiting public access points such as cafes, libraries, and schools by its scalable domain name system triage provisioned as a service. The present invention may be easily distinguished from conventional web filters by providing a personalized and portable web filter profile which operates independently of a specific home, public, or business network or even a specific computer.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. A system to provide a selective personalized Web filtering service by selective proxy using a domain name system comprising:
a network, the network coupling
a client machine apparatus,
a Web filtering domain name system server apparatus,
a Web server apparatus having a first Internet protocol address and a domain name.

2. The system of claim 1 wherein the Web filtering domain name system server apparatus comprises
a white list database comprising at least one first Internet protocol address and a domain name, and
means for receiving a domain name request from the client machine apparatus.

3. The system of claim 2 wherein the Web filtering domain name system server apparatus comprises
a processor adapted by a software program to
search the white list for the domain name and, if found,
return the first Internet protocol address of the Web server apparatus to the client machine apparatus.

4. The system of claim 3 further comprising
a web filtering extended proxy apparatus having a second Internet protocol address and wherein the Web filtering domain name system server apparatus comprises
a processor adapted by a software program
to search a white list for the domain name and if not found,
to return the second Internet protocol address of the Web filtering extended proxy apparatus,
whereby the client machine is directed to send the actual full URI of an HTTP request to the Web filtering extended proxy apparatus.

5. The system of claim 1 further comprising a Web filtering response portal server having a third Internet protocol address comprising
means for receiving an HTTP request from a client machine apparatus and
means for serving a block page.

6. The system of claim 5 wherein the Web filtering domain name system server apparatus further comprises
a blacklist database comprising at least one domain name and further comprising
a processor adapted by a software program
to search the blacklist database for the domain name and if found
to return the third Internet protocol address of the Web filtering response portal server
whereby the client machine is directed to send actual full URI of an HTTP request to the Web filtering response portal server.

7. The system of claim 1 wherein the client machine is adapted at network connection to send domain name system requests to the Web filtering domain name system server apparatus.

8. The system of claim 1 wherein the client machine is adapted at user logon to send DNS requests t
a certain personalized Web filtering domain name system server apparatus.

9. The system of claim 1 wherein the network comprises one of
a mesh network,
a cellular network, and
a wireless network.

10. The system of claim 1 wherein the network is a wide area network.

11. An apparatus to provide a selective personalized Web filtering service by extended proxy comprising:
a plurality of network interfaces,
means for receiving a full URI of an HTTP request,
means for examining the full URI for a deeply buried URI within the full URI,
means for determining if traffic to or from the buried URI is not allowed, and
means for blocking the traffic if it is not allowed.

12. The apparatus of claim 11 further comprising
a blacklist database and
a processor adapted
to examine a URI for buried URI on the blacklist and
to block it if found.

13. The apparatus of claim 11 further comprising
a proxy server apparatus adapted by a software program
to request a response from a Web server on behalf of a client and
to examine the response for objectionable content and
to return a block page if objectionable content is found.

14. The apparatus of claim 11 further comprising
a blacklist database of domain names and
means for returning a third Internet protocol address on the condition that a client machine submits a DNS request containing a domain name found on the blacklist.

15. The apparatus of claim 11 further comprising
a response server,
having a third Internet protocol address and
comprising means for serving a block page.

16. The apparatus of claim 11 further comprising
authentication means of a client machine as a subscriber of a service.

17. The apparatus of claim 11 further comprising
authentication means of a user as a subscriber of a service.

18. The apparatus of claim 11 further comprising
means for fulfillment of a Web page request to the requesting client machine if no objectionable content is found and if the full URI does not contain a URI found in the blacklist.

19. A method for operating a system, the system comprising three services: query string proxy, URI path scanner, and domain name system triage, wherein each service views the processor adapted by a program product and coupled to each other via a network; the method comprising:
within a query string proxy apparatus
sending a request on behalf of a client and analyzing a response from a remote server;
within a URI path scanner apparatus
receiving an entire path of a uniform resource identifier, and
performing keyword matching on labels within the uniform resource identifier; within a domain name system triage service apparatus
receiving a UDP request prior to establishing any protocol session between a client and a server and returning one IP address selected from the following: a block IP address, a trusted IP address, and a redirection to enhanced filter service IP address.

20. The method of claim 19 further comprising the following steps:
within a domain name system service apparatus,
searching a database of domain names to determine if a block IP address or a trusted IP address corresponds t
a domain name system, wherein a block IP address is one of a loopback address and an address of message server serving an html message; within a URI path scanner apparatus,
returning a block IP address if a label within the uniform resource identifier is matched with any member of a list of keywords consistent with undesirable content; within a query string proxy apparatus,
receiving from a server in response t
any URI which triggers a script or program or database retrieval,
analyzing the response for images or text with undesirable content, and
returning a message or block IP address to the client.
